(19) United States
(12) Patent Application Publication
(10) Pub. No.: US 2019/0261548 A1
(43) Pub. Date: Aug. 29, 2019

(54) DIGGING TOOL SYSTEM

(71) Applicant: Peter Flaatten, Port Alberni (CA)

(72) Inventor: Peter Flaatten, Port Alberni (CA)

(21) Appl. No.: 15/903,576

(22) Filed: Feb. 23, 2018

(51) Int. Cl. A01B 1/02; A01B 1/08; B25D 7/00

(52) U.S. Cl. CPC A01B 1/02; B25D 7/00; A01B 1/08

(57) ABSTRACT

A digging tool system provides a combination pickaxe and shovel superior to other digging tools in that it effectively allows a user to both break apart dense or impacted material and to move the material with a single tool. The digging device includes a digging head with a generally triangular blade which is capable of penetrating and moving substrate. The blade has a vertically and horizontally curved face, with a greater depth of curve on one side of the horizontal curvature, and a substrate-piercing tip formed by the apex of the blade which is positioned off-center relative to a handle. The greater depth on one side and the off-center placement of the substrate-piercing tip allow for material to be moved to one side as the digging device is pulled through the material.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of earth working and more specifically relates to hand tool.

### 2. Description of Related Art

Digging is a process that is required for many situations and projects. The process of digging can vary quite a bit depending on the nature of the earth or substrate that needs to be moved. In cases where the earth or substrate is soft or loose, a shovel can be used to simply scoop material and move it to a desired area. In cases where the earth or substrate is heavy, hard, or densely packed it is very difficult to scoop the material which can cause a lot of strain on the worker. In some cases, a pick-axe may be used to break up the material making it easier to be scooped by a shovel, and then moved to a desired area. This means that a user must have multiple tools, and perform multiple actions, or possibly that additional workers must be used to manage the additional tools. A solution which alleviates the need for multiple tools or workers is desired.

U.S. Pub. No. 2003/0230419 to Loy Eubanks relates to a garden tool for grubbing. The described garden tool for grubbing includes an elongated handle attached with and approximately perpendicular to, a grub hoe blade. The grub hoe blade has a proximal end and a distal end wherein the distal end is narrower than the proximal end. The grub hoe blade may include a rounded tip or the distal end may be straight. The end and the sides of the grub hoe blade are sharp to allow the grub hoe blade to easily penetrate compact or rooty soil. The grub hoe blade is arcuate and the neck is connected with the handle approximately central to the grub hoe blade along a longitudinal axis, thereby balancing the present garden tool for grubbing during use.

### BRIEF SUMMARY OF THE INVENTION

In view of the foregoing disadvantages inherent in the known earth working means art, the present disclosure provides a novel digging tool system. The general purpose of the present disclosure, which will be described subsequently in greater detail, is to provide a combination pickaxe and shovel. The present invention is superior to other digging tools in that it effectively allows a user to both break apart dense or impacted material and to move the material with a single tool. The digging device includes a digging head with a generally triangular blade which is capable of penetrating and moving substrate. The blade has a vertically and horizontally curved face, with a greater depth of curve on one side of the horizontal curvature. The apex of the generally triangular blade provides a substrate-piercing-tip which is preferably positioned off-center (offset) relative to a handle. The digging head also includes an integral handle support frame with an end cap and at least one elongated support arm which are used to affix a handle. The greater depth of curvature on one side, and the off-center position of the substrate-penetrating-tip allow for material to be moved to one side as the digging device is ‘pulled’ through the material.

A digging tool system is disclosed herein. The digging tool system includes a digging device; the digging device comprising a digging head, the digging head including: a generally triangular blade capable of penetrating and moving substrate. The generally triangular blade may have a curved face with vertical and horizontal curvature with the horizontal curvature having a greater depth on one side and terminating in an apex with an acute angle which may be positioned off-center relative to a handle. The apex forms a substrate-piercing-tip; and an integral handle support frame. The integral handle support frame may have an end cap and at least one elongated support arm; and the handle. The digging device may be configured to move a volume of the substrate allowing the substrate to be repositioned during a hoeing-digging process. The device can be used to furrow or row sluffing off the substrate in the desired direction.

A method of using digging tool systems is also disclosed herein. The method of using digging tool systems may comprise the steps of: providing a digging device, the device including: a digging head may include a generally triangular blade with a substrate-piercing-tip, and an integral handle support frame; and a handle; gripping the handle so that the substrate-piercing tip may be pointing downward; swinging the digging device downward; plunging the digging device into the substrate; pulling the digging device toward the user through the substrate. The method of using digging tool systems may further comprise the steps of: scooping the substrate; lifting the digging device; and depositing the substrate to a desired area.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a digging tool system, constructed and operative according to the teachings of the present disclosure.

FIG. 1 is a perspective view of the digging tool system during an ‘in-use’ condition, according to an embodiment of the disclosure.

FIG. 2 is a side perspective view of the digging tool system of FIG. 1, according to an embodiment of the present disclosure.

FIG. 3 is a top perspective view of the digging tool system of FIG. 1, according to an embodiment of the present disclosure.

FIG. 4 is a side perspective view of the digging tool system of FIG. 1, according to an embodiment of the present disclosure.

FIG. 5 is a flow diagram illustrating a method of use for the digging tool systems, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to earth working and more particularly to a digging tool system as used to improve the use of hand tools.

Generally, the present invention provides a multi-purpose digging tool which is a pickaxe combined with a shovel. It resembles a tilling blade from larger farm equipment but is lighter and more practical as a hand tool. The handle connecting to the head of the digging tool is at a particular angle in relation to the digging head so that driving down into the dirt is very easy, and once the head is in the dirt the leverage on the handle makes it easy to drag the dirt around. The blade has a pointed tip to make penetrating hard ground relatively easy.

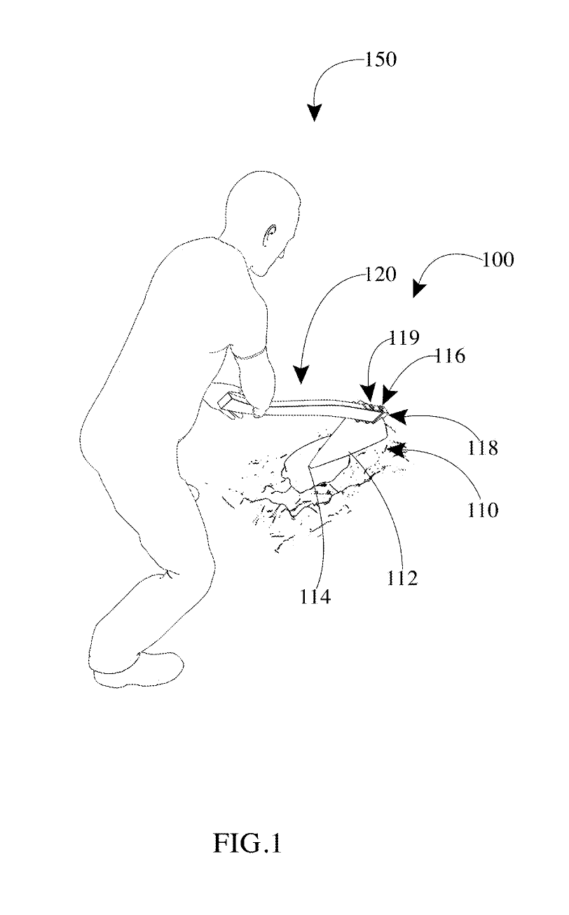

Referring now more specifically to the drawings by numerals of reference, there is shown in FIGS. 1-4, various views of a digging tool systems 100. FIG. 1 shows a digging tool system 100 during an ‘in-use’ condition 150, according to an embodiment of the present disclosure. As illustrated, the digging tool system 100 may include a digging device comprising a digging head 110 having a generally triangular blade 112 capable of penetrating and moving substrate. The generally triangular blade 112 may have a curved face with vertical and horizontal curvature with the horizontal curvature having a greater depth on one side (left or right-hand depending on embodiment).

The generally triangular blade 112 terminates in an apex having an acute angle forming a substrate-piercing-tip 114 which is positioned off-center relative to a handle 120. The greater horizontal curvature depth on one side and the off-center position of the substrate-piercing-tip 114 allow for substrate to be moved to an opposite-side when the digging head 110 is inserted into and pulled through substrate. The digging device preferably includes an integral handle support frame 116, which has an end cap 118 and at least one elongated support arm 119. The digging device is configured to move a volume of substrate allowing the substrate to be repositioned during a hoeing-digging process.

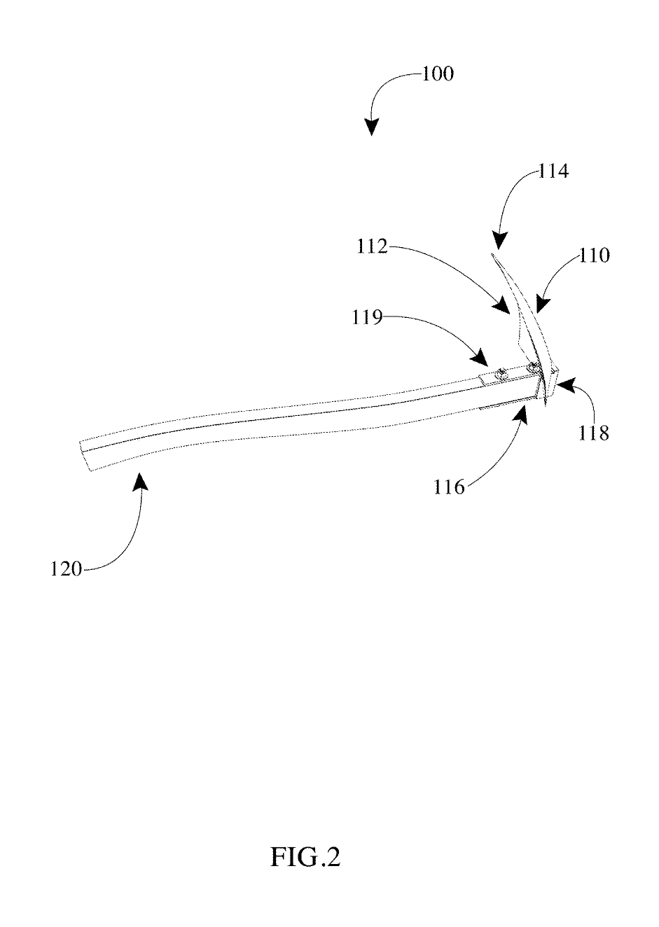

FIG. 2 shows a side perspective view of the digging tool systems 100 of FIG. 1, according to an embodiment of the present disclosure. As above, the digging tool system 100 may include a digging device comprising a digging head 110 having a generally triangular blade 112 having a curved face with vertical and horizontal curvature with the horizontal curvature having a greater depth on one side and which terminates in an apex having an acute angle forming a substrate-piercing-tip 114 which is positioned off-center relative to a handle 120. The greater depth and substrate-piercing-tip 114 are positioned off-center on the left-side of the digging head 110 in certain embodiments. The substrate-piercing-tip 114 points generally downward during use and is slope-contoured and occupies a position rearward of a distal end of the handle 120 and nearer a proximal end of the handle 120.

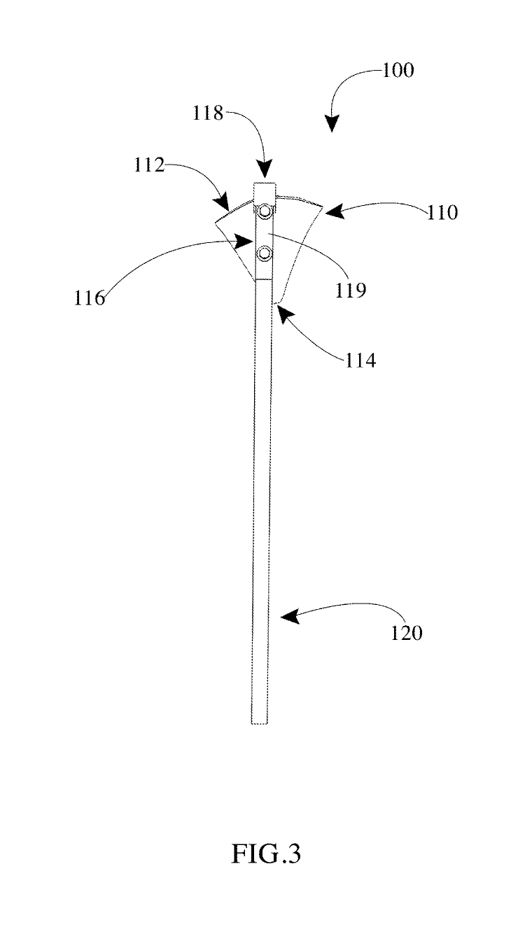

Referring now to FIG. 3 showing a top perspective view of the digging tool systems 100 of FIG. 1, according to an embodiment of the present disclosure. As above, the digging tool system 100 may include digging device comprising a digging head 110 having a generally triangular blade 112 having a curved face with vertical and horizontal curvature with the horizontal curvature having a greater depth on one side and which terminates in an apex having an acute angle forming a substrate-piercing-tip 114 which is positioned off-center relative to a handle 120. The greater depth and substrate-piercing-tip 114 are positioned off-center on the right-side of the digging head 110 in certain embodiments. The digging head 110 also includes an integral handle support frame 116 which is removably affixed to the handle 120 using fasteners or other suitable means. In an alternate embodiment, the integral handle support frame 116 is removably affixed to the handle 120 using a compression fit. The integral handle support frame 116 includes an end cap 118 that fits over the distal end of the handle 120, with the distal end of the handle 120 being nested within the end cap 118. The integral handle support 116 frame further comprises at least one elongated support arm 119 which extends from the end cap 118 and is adjacent and in physical contact with the handle 120; the handle 120 being parallel to the at least one elongated support arm 119 as nested and contours offset as approaching the proximal end of the handle 120. The handle 120 is made of a material selected from the group consisting of: wood, plastic, fiberglass, carbon fiber, ferrous material, non-ferrous material, and composite material.

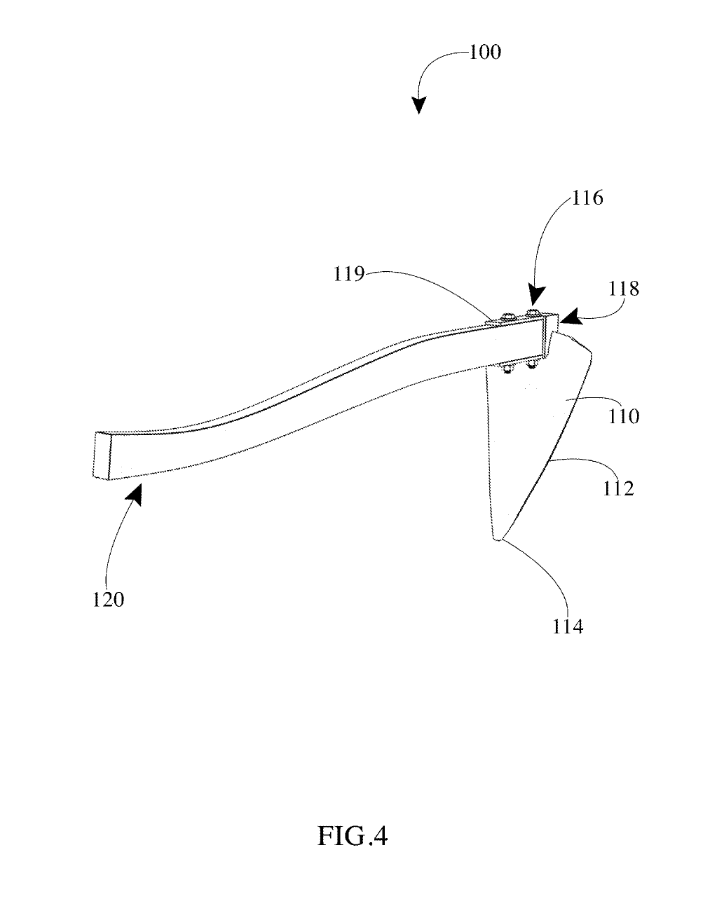

FIG. 4 shows a side perspective view of the digging tool systems 100 of FIG. 1, according to an embodiment of the present disclosure. As above, the digging tool system 100 may include a digging head 110 which comprises a scooped member and is preferably made from a ferrous material. In certain embodiments the digging head 110 includes a titanium edge along one side. According to one embodiment, the digging tool system 100 may be arranged as a kit. The kit may include a digging device and instructions. The instructions may detail functional relationships in relation to the structure of the digging tool system 100 (such that the digging tool system 100 can be used, maintained, or the like, in a preferred manner).

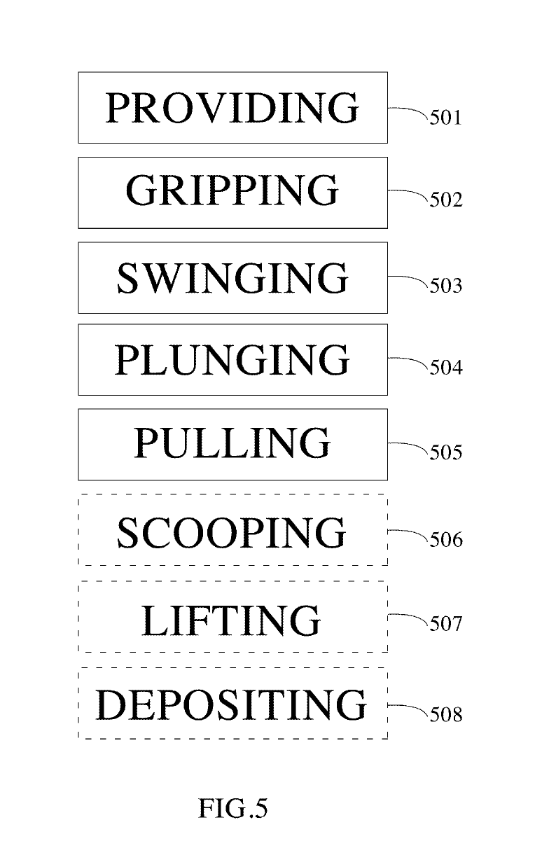

Referring now to FIG. 5, a flow diagram 550 illustrating a method for using a digging device 500, according to an embodiment of the present disclosure. As illustrated, the a method for using a digging device 500 may include the steps of: providing 501 a digging device, the device including: a digging head having a generally triangular blade with a substrate-piercing-tip, an integral handle support frame, and a handle; gripping 502 the handle so that the substrate-piercing tip may be pointing downward; swinging 503 the digging device downward; plunging 504 the digging device into the substrate; and pulling 505 the digging device toward the user through the substrate. The method of using digging tool systems may further comprise the steps of: scooping 506 the substrate; lifting 507 the digging device; and depositing 508 the substrate to a desired area.

It should be noted that steps 506, 507, and 508 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for digging tool systems 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A digging tool system comprising:
a digging device, said digging device comprising
a digging head, said digging head including:
a generally triangular blade capable of penetrating and moving substrate,
said generally triangular blade having a curved face with vertical and horizontal curvature with said horizontal curvature having a greater depth on one side and terminating in an apex having an acute angle which is positioned off-center relative to a handle, said apex forming a substrate-piercing-tip; and
an integral handle support frame, said integral handle support frame having an end cap and at least one elongated support arm; and
said handle;
wherein said digging device is configured to move a volume of said substrate allowing said substrate to be repositioned during a hoeing-digging process.

2. The digging tool system of claim 1, wherein said generally triangular blade having said curved face with said vertical and horizontal curvature having said greater depth on said one side allows for said substrate to be moved to an opposite-side allowing said greater depth to be employed when inserted into and pulled through said substrate.

3. The digging tool system of claim 2, wherein said greater depth is located on a left-side of said digging head.

4. The digging tool system of claim 2, wherein said greater depth is located on a right-side of said digging head.

5. The digging tool system of claim 3, wherein said substrate-piercing-tip is positioned off-center on the left-side of said digging head.

6. The digging tool system of claim 4, wherein said substrate-piercing-tip is positioned off-center on the right-side of said digging head.

7. The digging tool system of claim 1, wherein said substrate-piercing-tip points generally downward during use when piercing said substrate.

8. The digging tool system of claim 7, wherein said substrate-piercing-tip is slope-contoured said substrate-piercing-tip occupying a position rearward of a distal end of said handle and nearer a proximal end of said handle.

9. The digging tool system of claim 1, wherein said integral handle support frame is removably affixed to said handle.

10. The digging tool system of claim 9, wherein said integral handle support frame is affixed to said handle using fasteners.

11. The digging tool system of claim 9, wherein said integral handle support frame is affixed to said handle using a compression fit.

12. The digging tool system of claim 8, wherein said end cap fits over the distal end of said handle, said distal end of said handle nested within said end cap.

13. The digging tool system of claim 12, wherein said at least one elongated support arm extends from said end cap and is adjacent and in physical contact with said handle wherein said handle is parallel to said elongated support arm as nested and contours offset as approaching said proximal end of said handle.

14. The digging tool system of claim 1, wherein said digging head comprises a scooped member.

15. The digging tool system of claim 1, wherein said digging head is made of ferrous material.

16. The digging tool system of claim 15, wherein said digging head includes a titanium edge along said one side.

17. The digging tool system of claim 1, wherein said handle is made of a material selected from the group consisting of:
wood, plastic, fiberglass, carbon fiber, ferrous material, non-ferrous material, and composite material.

18. A digging device, the digging device comprising:
a digging head, said digging head including:
a generally triangular blade capable of penetrating and moving substrate,
said generally triangular blade having a curved face with vertical and horizontal curvature with said horizontal curvature having a greater depth on one side and terminating in an apex having an acute angle which is positioned off-center relative to a handle, said apex forming a substrate-piercing-tip; and
an integral handle support frame, said integral handle support frame having an end cap and at least one elongated support arm; and
said handle;
wherein said digging device is configured to move a volume of said substrate allowing said substrate to be repositioned during a hoeing-digging process;
wherein said generally triangular blade having said curved face with said vertical and horizontal curvature having said greater depth on said one side allows for said substrate to be moved to an opposite-side allowing said greater depth to be employed when inserted into and pulled through said substrate to create rowing;
wherein said substrate-piercing-tip is positioned off-center on the left-side of said digging head;
wherein said substrate-piercing-tip is positioned off-center on the right-side of said digging head;
wherein said substrate-piercing-tip points generally downward during use when piercing said substrate;
wherein said substrate-piercing-tip is slope-contoured said substrate-piercing-tip occupying a position rearward of a distal end of said handle and nearer a proximal end of said handle;
wherein said integral handle support frame is removably affixed to said handle;
wherein said integral handle support frame is affixed to said handle using fasteners;
wherein said end cap fits over the distal end of said handle, said distal end of said handle nested within said end cap;
wherein said at least one elongated support arm extends from said end cap and is adjacent and in physical contact with said handle wherein said handle is parallel to said elongated support arm as nested and contours offset as approaching said proximal end of said handle;
wherein said digging head comprises a scooped member;
wherein said digging head is made of ferrous material; and
wherein said digging head includes a titanium edge along said one side.

19. A method for using a digging device, the method comprising the steps of: providing a digging device, the device including:
a digging head including a generally triangular blade with a substrate-piercing-tip, and an integral handle support frame; and a handle;
gripping said handle so that said substrate-piercing tip is pointing downward;
swinging said digging device downward;
plunging said digging device into said substrate; and
pulling said digging device toward the user through said substrate.

20. The method of claim 20, further comprising the steps of:
scooping said substrate;
lifting said digging device; and
depositing said substrate to a desired area.
